(19) United States
(12) Patent Application Publication
(10) Pub. No.: US 2013/0127995 A1
(43) Pub. Date: May 23, 2013

(54) PREPROCESSING APPARATUS IN STEREO MATCHING SYSTEM

(71) Applicant: Junseo LEE, Seoul (KR)

(72) Inventor: Junseo LEE, Seoul (KR)

(21) Appl. No.: 13/543,070

(22) Filed: Jul. 6, 2012

(30) Foreign Application Priority Data
Nov. 23, 2011 (KR) 10-2011-0123177

(51) Int. Cl. H04N 13/02

(52) U.S. Cl. 348/46; 348/E13.074

(57) ABSTRACT

A preprocessing apparatus in a stereo matching system is provided. In the preprocessing apparatus, coordinate information of a stereo camera is stored, a new address of the pixel is specified using the coordinate information, and left and right images received from the stereo camera are rectified using the new address of the pixel.

### CROSS-REFERENCE TO RELATED APPLICATION

This application claims the benefit of Korean Patent Application No. 2011-123177, filed Nov. 23, 2011, the disclosure of which is hereby incorporated herein by reference in its entirety.

### BACKGROUND OF THE INVENTION

1. Field of the Invention

An aspect of the present invention relates to a technique for preprocessing a three-dimensional image, and more particularly, to a preprocessing apparatus in a stereo matching system used in a stereo camera, etc.

2. Description of the Related Art

As known well, person's sight is one of senses for obtaining peripheral environment information, and the position and distance of an object can be recognized through both eyes. That is, sight information received through both the eyes is combined as distance information, so that the person can move freely without feeling inconvenience.

A stereo camera system is used when the structure of the person's sight is implemented using a mechanism.

In the stereo camera system, stereo matching is performed on an image obtained using two cameras. In this case, external and internal structures of the two cameras are different from each other. Therefore, to equalize the internal structures of the two cameras, in a conventional stereo matching system, preprocessing is performed by creating a reference table for differences between the two cameras and applying values in the reference table to each of the two cameras.

However, since a plurality of nonvolatile memories (ROMs) should be used in the conventional stereo matching system using the reference table, the size of hardware increases, and the price of the hardware rises.

### SUMMARY OF THE INVENTION

Embodiments of the present invention provide a preprocessing apparatus in a stereo matching system, in which the number of nonvolatile memories is decreased, and weight information of stereo cameras is provided as an equal value, so that the size and price of hardware can be decreased while maintaining the same performance.

It is to be understood that technical problems to be solved by the present invention are not limited to the aforementioned technical problems and other technical problems which are not mentioned will be apparent from the following description to the person with an ordinary skill in the art to which the present invention pertains.

According to an aspect of the present invention, there is provided a preprocessing apparatus comprising a first storage configured to store coordinate information of a stereo camera; and a preprocessing unit configured to specify a new address of a pixel using the coordinate information, and to rectify left and right images received from the stereo camera using the new address of the pixel.

The first storage unit may comprise a second storage configured to store a left row position in the coordinate information, a third storage configured to store a left column position in the coordinate information, a fourth storage configured to store a right row position in the coordinate information, and a fifth storage configured to store a right column position in the coordinate information.

The second to fifth storages may include nonvolatile memories.

The preprocessing unit may comprise an address generator configured to specify the new address of the pixel of the image, using the coordinate information; and an interpolator configured to interpolate the left and right images, using the new address of the pixel and weight information of the stereo camera.

The preprocessing unit may further comprise a sixth storage configured to store the left and right images received from the stereo camera.

The sixth storage may include a volatile memory.

The weight information may be provided as a predetermined value to the interpolator.

The predetermined value may be substantially 0.25.

The interpolator may apply the weight information to the new address of the pixel to obtain an average of the corresponding pixel.

The preprocessing unit may include a left address generator configured to specify a new address of the pixel of the left image, using the left row position and the left column position, a right address generator configured to specify a new address of the pixel of the right image, using the right row position and the right column position, a left interpolator configured to interpolate the left image, using the new address of the pixel of the left image and left weight information of the stereo camera, and a right interpolator configured to interpolate the right image, using the new address of the pixel of the right image and right weight information of the stereo camera.

The preprocessing unit may further comprise a seventh storage configured to store the left image, and an eighth storage configured to store the right image.

The seventh and eighth storages may include volatile memories.

The left weight information and the right weight information may be provided as predetermined values to the left interpolator and the right interpolator, respectively.

The predetermined value may be substantially 0.25.

The left interpolator may apply the left weight information to the new address of the pixel of the left image to obtain an average of the corresponding pixel.

The right interpolator may apply the right weight information to the new address of the pixel of the right image to obtain an average of the corresponding pixel.

As described above, in the preprocessing apparatus in the stereo matching system according to the present invention, the number of nonvolatile memories used in the conventional preprocessing apparatus is decreased, so that it is possible to decrease the size of the system and to reduce cost.

Further, an image is interpolated by equalizing weight information of a stereo camera as a predetermined value, so that the calculation of an interpolator can be simplified.

Further, the expression of specifying a new address of the pixel is replaced with an equivalent expression, thereby simplifying calculation for address generation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a configuration view illustrating a conventional preprocessing apparatus in a stereo matching system;

FIG. 2 is a configuration view illustrating a preprocessing apparatus in a stereo matching system according to an embodiment of the present invention;

FIG. 3 is an exemplary view illustrating a rectified image output by the conventional preprocessing apparatus in the stereo matching system; and

FIG. 4 is an exemplary view illustrating a rectified image output by the preprocessing apparatus in the stereo matching system according to the embodiment of the present invention.

### DETAILED DESCRIPTION OF THE INVENTION

The present invention is described more fully hereinafter with reference to the accompanying drawings, in which embodiments of the present invention are shown. This present invention may, however, be embodied in many different forms and should not be construed as limited to the embodiments set forth herein. Rather, these embodiments are provided so that this disclosure is thorough, and will fully convey the scope of the present invention to those skilled in the art.

It will be understood that, although the terms “first,” “second,” etc. may be used herein to describe various elements, these elements should not be limited by these terms. These terms are only used to distinguish one element from another element. Thus, a “first” element discussed below could also be termed as a “second” element without departing from the teachings of the present invention.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise.

It will be further understood that the terms “includes” and/or “including,” when used in this specification, specify the presence of stated features, integers, steps, operations, elements, and/or components, but do not preclude the presence and/or addition of one or more other features, integers, steps, operations, elements, components, and/or groups thereof.

In the drawings, the thickness of layers, films and regions are exaggerated for clarity. Like numerals refer to like elements throughout.

Hereinafter, a conventional preprocessing apparatus will be first described, and a preprocessing apparatus according to an embodiment of the present invention will be then described in detail with reference to the accompanying drawings.

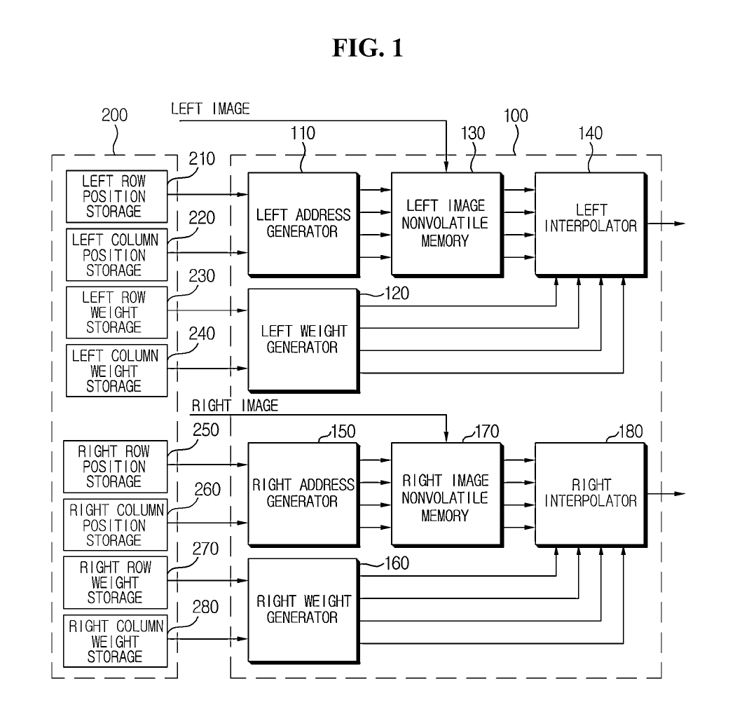

FIG. 1 is a configuration view illustrating a conventional preprocessing apparatus in a stereo matching system.

The conventional preprocessing apparatus in the stereo matching system rectifies left and right images respectively provided from two stereo cameras (not shown) using rectification parameters, and outputs the rectified left and right images by aligning epipolar lines of the left and right images.

The conventional preprocessing apparatus includes a preprocessing unit 100 and a nonvolatile memory unit 200. The nonvolatile memory unit 200 includes a left row position storage 210, a left column position storage 220, a left row weight storage 230, a left column weight storage 240, a right row position storage 250, a right column position storage 260, a right row weight storage 270 and a right column weight storage 280.

As such, the non-volatile memory unit 200 stores coordinate information including a left row position, a left column position, a right row position, a right column position, etc., and weight information including a left row weight, a left column weight, a right row weight, a right column weight, etc.

A left address generator 110 evaluates an address using data stored in the left row and column position storages 210 and 220 according to the following expressions. A right address generator 150 evaluates an address using data stored in the right row and column position storages 250 and 260 according to the following expressions.

x←(u−c′ₓ)/f′ₓ

y←(v−c′_{y})/f′_{y} Expression 1

[X Y W]^{T}←R^{T}×[x y 1]^{T} Expression 2

x′←X/W

y′←Y/W Expression 3

x″←x′(1+k₁r²+k₂r⁴+k₃r⁶)+2p₁x′y′+p₂(r²+2x′²)

y″←y′(1+k₁r²+k₂r⁴+k₃r⁶)+p₁(r²+2y′²)+2p₂x′y′ Expression 4

mapₓ(u,v)←x″+fₓ+cₓ

map_{y}(u,v)←y″f_{y}+c_{y} Expression 5

The addresses of pixels, respectively output by the left and right address generators 110 and 150, are finally obtained through Expression 5.

In this case, the original camera matrix is

$$A = [ \begin{matrix}{f}_{x} & 0 & {c}_{x} \\ 0 & {f}_{y} & {c}_{y} \\ 0 & 0 & 1\end{matrix} ]$$

where fₓ denotes an original x-axis scale factor, f_{y} denotes an original y-axis scale factor, cₓ denotes an original x-axis principal point, and c_{y} denotes an original y-axis principal point.

The generated new camera matrix is

$$A = [ \begin{matrix}{f}_{x}^{′} & 0 & {c}_{x}^{′} \\ 0 & {f}_{y}^{′} & {c}_{y}^{′} \\ 0 & 0 & 1\end{matrix} ]$$

where f′ₓ denotes a new x-axis scale factor, f′_{y} denotes a new y-axis scale factor, c′ₓ denotes a new x-axis principal point, and c′_{y} denotes a new y-axis principal point.

When assuming that the size of an image is N×M, u denotes an x-axis pixel index from 1 to N, and v denotes a y-axis pixel index from 1 to M. The left and right address generators 110 and 150 perform calculations as described above by respectively obtaining new addresses of pixels corresponding to pixels from (1, 1) to (N, M). In this case, k₁, k₂, p₁ and p₂ denote distortion variables.

A left weight generator 120 generates a left weight using left row and column weights stored in the left row and column weight storages 230 and 240. A right weight generator 160 generates a right weight using right row and column weights stored in the right row and column weight storages 270 and 280.

Left and right interpolators 140 and 180 interpolate left and right images using the left and right addresses and the left and right weights, generated as described above, respectively.

However, since at least eight nonvolatile memories are necessarily used in the conventional preprocessing apparatus, the size of the system is increased, and a large amount of cost is required.

In order to solve the aforementioned problem of the conventional system, the present invention uses nonvolatile memories of which number is smaller than that of nonvolatile memories used in the conventional preprocessing apparatus, so that it is possible to decrease the size of a system, to reduce the complexity of calculation and to save cost.

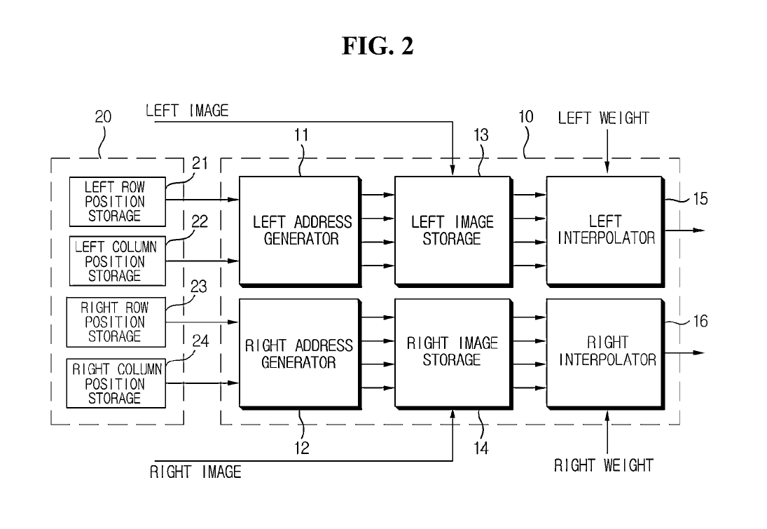

FIG. 2 is a configuration view illustrating a preprocessing apparatus in a stereo matching system according to an embodiment of the present invention.

As shown in FIG. 2, the preprocessing apparatus according to the embodiment of the present invention includes a preprocessing unit 10 and a nonvolatile memory unit 20.

The nonvolatile memory unit 20 comprises a left row position storage 21, a left column position storage 22, a right row position storage 23 and a right column position storage 24.

The nonvolatile memory unit 20 is configured as a nonvolatile memory, and each of the storages 21 to 24 includes one nonvolatile memory. The nonvolatile memory is a memory that continuously maintains information stored therein without power supply, and a read only memory (ROM) is used as a representative of the nonvolatile memory.

The preprocessing unit 10 includes a left address generator 11, a right address generator 12, a left image storage 13, a right image storage 14, a left interpolator 15 and a right interpolator 16.

The left and right image storages 13 and 14 are used to respectively store left and right images obtained by a stereo camera (not shown). The left and right image storages 13 and 14 are preferably volatile memories.

The volatile memory refers to a computer memory that requires electricity so as to maintain information stored therein, and is also called as a temporary memory. A random access memory (RAM) is used as a representative of the volatile memory.

That is, the left and right image storages 13 and 14 temporarily store the respective left and right images from the stereo camera (not shown) and provide the stored left and right images to the respective left and right interpolators 15 and 16.

The left row and column position storages 21 and 22 of the nonvolatile memory unit 20 store coordinate information (a left row position and a left column position) of the stereo camera (not shown) providing the left image, and the right row and column position storages 23 and 24 of the nonvolatile memory unit 20 store coordinate information (a right row position and a right column position) of the stereo camera (not shown) providing the right image.

In the conventional preprocessing apparatus of FIG. 1, the weight information of the stereo cameras, i.e., the left row weight, the left column weight, the right row weight and the right column weight, respectively stored in the left row weight storage 230, the left column weight storage 240, the right row weight storage 270 and the right column weight storage 280, are provided to the left and right interpolators 140 and 180. On the other hand, in the preprocessing apparatus according to the embodiment of the present invention, predetermined values (e.g., 0.25) are provided as left and right weights to the left and right interpolators 15 and 16, respectively.

In this case, the left weight includes a left row weight and a left column weight, and the right weight includes a right row weight and a right column weight.

The left and right address generators 11 and 12 according to the embodiment of the present invention respectively generate new addresses of pixels, by developing Expressions 1 to 5 into equivalents as represented by the following Expressions 6 to 10.

x←(u−c′ₓ)/f′ₓ

y←(v−c′_{y})/f′_{y} Expression 6

In this case, the left and right address generators 11 and 12 are assumed as R=I in Expression 2. Here, I denotes an identity matrix, and therefore, R⁻¹=I. That is, Expression 2 is developed as represented by the following Expression 7.

[X Y W]^{T}←[x y 1]^{T} Expression 7

x′←x

y′←y Expression 8

Thus, the calculation of Expression 8 is simplified as compared with that of Expression 3.

x″←x′(1+k₁r²+k₂r⁴)+2p₁x′y′+p₂(r²+2x′²)

y″←y′(1+k₁r²+k₂r⁴)+p₁(r²+2y′²)+2p₂x′y′ Expression 9

mapₓ(u,v)←x″fₓ+cₓ

map_{y}(u,v)←y″f_{y}+c_{y} Expression 10

The left and right address generators 11 and 12 according to the embodiment of the present invention simplify calculation as represented by Expression 9 by omitting the term r⁶ in Expression 4. Since r⁶ is a very small decimal point in terms of features of the stereo camera, r⁶ is a very small value. Therefore, r⁶ may be omitted.

Thus, it can be considered that the equivalent expression described above is an optimized expression, in consideration of circuit complexity, cost and performance.

The new addresses of the pixels, finally output by the respective left and right address generators 11 and 12 are obtained by Expression 10.

In this case, the original camera matrix of rectification parameters is

$$A = [ \begin{matrix}{f}_{x} & 0 & {c}_{x} \\ 0 & {f}_{y} & {c}_{y} \\ 0 & 0 & 1\end{matrix} ]$$

where fₓ denotes an original x-axis scale factor, f_{y} denotes an original y-axis scale factor, cₓ denotes an original x-axis principal point, and c_{y} denotes an original y-axis principal point.

The generated new camera matrix of rectification parameters is

$$A = [ \begin{matrix}{f}_{x}^{′} & 0 & {c}_{x}^{′} \\ 0 & {f}_{y}^{′} & {c}_{y}^{′} \\ 0 & 0 & 1\end{matrix} ]$$

where f′ₓ denotes a new x-axis scale factor, f′_{y} denotes a new y-axis scale factor, c′ₓ denotes a new x-axis principal point, and c′_{y} denotes a new y-axis principal point.

In this case, k₁, k₂, p₁ and p₂ denote distortion variables.

When assuming that the size of an image is N×M, u denotes an x-axis pixel index from 1 to N, and v denotes a y-axis pixel index from 1 to M. The left and right address generators 11 and 12 perform calculations as described above by obtaining new addresses of pixels corresponding to pixels from (1, 1) to (N, M).

The left interpolator 15 interpolates the left image temporarily stored in the left image storage 13 using the new addresses of the pixels generated by the left address generator 11 and the left weight input as an equal value. The right interpolator 16 interpolates the right image temporarily stored in the right image storage 14 using the new addresses of the pixels generated by the right address generator 12 and the right weight input as an equal value.

Specifically, the left interpolator 15 receives addresses of four pixels, i.e., top, bottom, left and right pixels, from the left address generator 11, and weight information is applied to the received addresses of the pixels, thereby obtaining an average of the corresponding pixels. The right interpolator 16 receives addresses of four pixels, i.e., top, bottom, left and right pixels, from the right address generator 12, and weight information is applied to the received addresses of the pixels, thereby obtaining an average of the corresponding pixels. In the embodiment of the present invention, the same value is provided to the left and right weights. However, the present invention is not limited thereto, and a case may occur in which the left and right weights are different from each other.

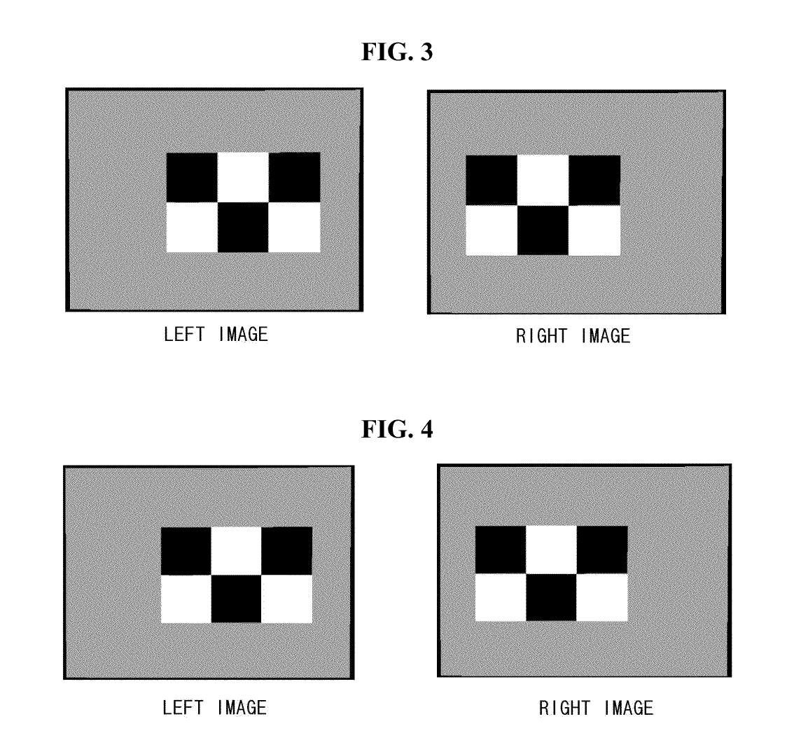

FIG. 3 is an exemplary view illustrating a rectified image output by the conventional preprocessing apparatus in the stereo matching system. FIG. 4 is an exemplary view illustrating a rectified image output by the preprocessing apparatus in the stereo matching system according to the embodiment of the present invention. FIGS. 3 and 4 illustrate left and right images, respectively.

As shown in FIGS. 3 and 4, in the preprocessing apparatus according to the embodiment of the present invention, weight information can be equally provided by removing the nonvolatile memories that have stored the weight information, and calculations can be simplified as compared with those in the conventional preprocessing apparatus. However, it can be seen that the rectified image performed as a result by the preprocessing apparatus according to the embodiment of the present invention is almost same as that performed as a result by the conventional preprocessing apparatus.

Although the present invention has been described in connection with the preferred embodiments, the embodiments of the present invention are only for illustrative purposes and should not be construed as limiting the scope of the present invention. It will be understood by those skilled in the art that various changes and modifications can be made thereto within the technical spirit and scope defined by the appended claims.

What is claimed is:

1. A preprocessing apparatus comprising:
a first storage configured to store coordinate information of a stereo camera; and
a preprocessing unit configured to specify a new address of a pixel using the coordinate information, and to rectify left and right images received from the stereo camera using the new address of the pixel.

2. The preprocessing apparatus of claim 1, wherein the first storage comprises:
a second storage configured to store a left row position in the coordinate information;
a third storage configured to store a left column position in the coordinate information;
a fourth storage configured to store a right row position in the coordinate information; and
a fifth storage configured to store a right column position in the coordinate information.

3. The preprocessing apparatus of claim 2, wherein the second to fifth storages include nonvolatile memories.

4. The preprocessing apparatus of claim 1, wherein the preprocessing unit comprises:
an address generator configured to specify the new address of the pixel of the image, using the coordinate information; and
an interpolator configured to interpolate the left and right images, using the new address of the pixel and weight information of the stereo camera.

5. The preprocessing apparatus of claim 4, wherein the preprocessing unit further comprises a sixth storage configured to store the left and right images received from the stereo camera.

6. The preprocessing apparatus of claim 5, wherein the sixth storage includes a volatile memory.

7. The preprocessing apparatus of claim 4, wherein the weight information is provided as a predetermined value to the interpolator.

8. The preprocessing apparatus of claim 7, wherein the predetermined value is substantially 0.25.

9. The preprocessing apparatus of claim 4, wherein the interpolator applies the weight information to the new address of the pixel to obtain an average of the corresponding pixel.

10. The preprocessing apparatus of claim 2, wherein the preprocessing unit comprises:
a left address generator configured to specify a new address of the pixel of the left image, using the left row position and the left column position;
a right address generator configured to specify a new address of the pixel of the right image, using the right row position and the right column position;
a left interpolator configured to interpolate the left image, using the new address of the pixel of the left image and left weight information of the stereo camera; and
a right interpolator configured to interpolate the right image, using the new address of the pixel of the right image and right weight information of the stereo camera.

11. The preprocessing apparatus of claim 10, wherein the preprocessor further comprises:
a seventh storage configured to store the left image; and
an eighth storage configured to store the right image.

12. The preprocessing apparatus of claim 11, wherein the seventh and eighth storages include volatile memories.

13. The preprocessing apparatus of claim 10, wherein the left weight information and the right weight information are provided as predetermined values to the left interpolator and the right interpolator, respectively.

14. The preprocessing apparatus of claim 13, wherein the predetermined value is substantially 0.25.

15. The preprocessing apparatus of claim 10, wherein the left interpolator applies the left weight information to the new address of the pixel of the left image to obtain an average of the corresponding pixel.

16. The preprocessing apparatus of claim 10, wherein the right interpolator applies the right weight information to the new address of the pixel of the right image to obtain an average of the corresponding pixel.
